(19) United States
(12) Patent Application Publication
(10) Pub. No.: US 2024/0243857 A1
(43) Pub. Date: Jul. 18, 2024

(54) METHOD AND APPARATUS FOR TYPE-1 HYBRID AUTOMATIC REPEAT REQUEST ACKNOWLEDGEMENT (HARQ-ACK) CODEBOOK DETERMINATION

(71) Applicant: LENOVO (BEIJING) LIMITED, Beijing (CN)

(72) Inventor: Haipeng LEI, Beijing (CN)

(21) Appl. No.: 18/559,206

(22) PCT Filed: May 11, 2021
(86) PCT No.: PCT/CN2021/093045

§ 371 Date: Nov. 6, 2023

(51) Int. Cl. H04L 1/1829

(52) U.S. Cl. CPC H04L 1/1861

(57) ABSTRACT

Embodiments of the present disclosure relate to HARQ-ACK codebook determination. According to some embodiments of the disclosure, a method may include: determining that HARQ-ACK feedback for a PDSCH on each candidate PDSCH reception occasion of a first plurality of candidate PDSCH reception occasions and HARQ-ACK feedback for a PDSCH on each candidate PDSCH reception occasion of a second plurality of candidate PDSCH reception occasions are to be multiplexed in a PUCCH in a first slot, wherein the PDSCH on each candidate PDSCH reception occasion of the first plurality of candidate PDSCH reception occasions is scrambled by a first RNTI specific to the UE and the PDSCH on each candidate PDSCH reception occasion of the second plurality of PDSCHs is scrambled by a second RNTI common to a group of UEs including the UE; and transmitting the PUCCH in the first slot.

### TECHNICAL FIELD

Embodiments of the present disclosure generally relate to wireless communication technology, and more particularly to hybrid automatic repeat request acknowledgement (HARQ-ACK) codebook determination.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH). In the case that a DCI schedules a PDSCH, the UE may transmit hybrid automatic repeat request acknowledgement (HARQ-ACK) feedback (e.g., HARQ-ACK information bit(s)) for the PDSCH through a PUSCH or a physical uplink control channel (PUCCH). For example, the PUCCH may carry a HARQ-ACK codebook including the HARQ-ACK feedback information bit(s) for the PDSCH.

There is a need for handling HARQ-ACK codebook determination in a wireless communication system.

### SUMMARY

Some embodiments of the present disclosure provide a method for wireless communication performed by a user equipment (UE). The method may include: determining that hybrid automatic repeat request acknowledgement (HARQ-ACK) feedback for a physical downlink shared channel (PDSCH) on each candidate PDSCH reception occasion of a first plurality of candidate PDSCH reception occasions and HARQ-ACK feedback for a PDSCH on each candidate PDSCH reception occasion of a second plurality of candidate PDSCH reception occasions are to be multiplexed in a physical uplink control channel (PUCCH) in a first slot, wherein the PDSCH on each candidate PDSCH reception occasion of the first plurality of candidate PDSCH reception occasions is scrambled by a first radio network temporary identifier (RNTI) specific to the UE and the PDSCH on each candidate PDSCH reception occasion of the second plurality of PDSCHs is scrambled by a second RNTI common to a group of UEs including the UE; and transmitting the PUCCH in the first slot.

Some embodiments of the present disclosure provide a method for wireless communication performed by a base station (BS). The method may include: indicating that hybrid automatic repeat request acknowledgement (HARQ-ACK) feedback for a physical downlink shared channel (PDSCH) on each candidate PDSCH reception occasion of a first plurality of candidate PDSCH reception occasions and HARQ-ACK feedback for a PDSCH on each candidate PDSCH reception occasion of a second plurality of candidate PDSCH reception occasions are to be multiplexed in a physical uplink control channel (PUCCH) in a first slot, wherein the PDSCH on each candidate PDSCH reception occasion of the first plurality of candidate PDSCH reception occasions is scrambled by a first radio network temporary identifier (RNTI) specific to a user equipment (UE) and the PDSCH on each candidate PDSCH reception occasion of the second plurality of PDSCHs is scrambled by a second RNTI common to a group of UEs including the UE; and receiving the PUCCH in the first slot.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Some embodiments of the present disclosure provide an apparatus. The apparatus may include a processor and a transceiver coupled to the processor. The processor and the transceiver may be configured to interact with each other to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings.

These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a HARQ-ACK feedback transmission in accordance with some embodiments of the present disclosure;

FIG. 3 illustrates an exemplary time domain resource allocation (TDRA) configuration in accordance with some embodiments of the present disclosure;

FIG. 3A illustrates an exemplary TDRA configuration in accordance with some embodiments of the present disclosure;

FIG. 3B illustrates an exemplary TDRA configuration in accordance with some embodiments of the present disclosure;

FIG. 4 illustrates a flow chart of an exemplary procedure of wireless communications in accordance with some embodiments of the present disclosure;

FIG. 5 illustrates a flow chart of an exemplary procedure of wireless communications in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

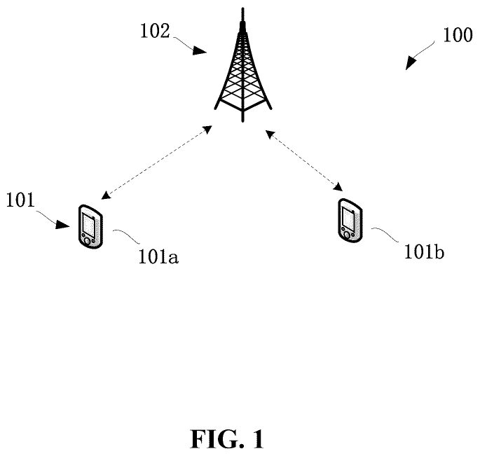

FIG. 1 illustrates a schematic diagram of a wireless communication system 100 in accordance with some embodiments of the present disclosure.

As shown in FIG. 1, a wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

Two types of HARQ-ACK codebooks may be defined for HARQ-ACK multiplexing for multiple received PDSCHs. One may be named a Type-1 HARQ-ACK codebook (also referred to as “semi-static HARQ-ACK codebook”), and another may be named a Type-2 HARQ-ACK codebook (also referred to as “dynamic HARQ-ACK codebook”). The definitions of the Type-1 HARQ-ACK codebook and Type-2 HARQ-ACK codebook are specified in 3GPP specifications.

For example, the size of a Type-1 HARQ-ACK codebook (e.g., the number of HARQ-ACK information bits included therein) may be independent of the actual scheduling situation. For instance, the number of HARQ-ACK information bits may be determined based on a list of parameters, including, for example, PDSCH-to-HARQ timing values (also referred to as “HARQ-ACK feedback timing set” or “K1 set”), the number of code block groups (CBGs) per component carrier (CC), and/or other(s). The K1 set may be configured to a UE via an RRC signaling message or predefined in a standard(s). For example, the K1 set may be configured by a higher layer parameter, e.g., dl-DataToUL-ACK in PUCCH-config information element (IE).

In some embodiments of the present disclosure, both a Type-1 HARQ-ACK codebook and Type-2 HARQ-ACK codebook may be supported for UEs receiving multicast transmissions (e.g., PDSCHs scrambled by a group-common radio network temporary identifier (RNTI)). In some embodiments of the present disclosure, for ACK/NACK based feedback, UEs receiving multicast can be optionally configured with a separate PUCCH configuration for multicast. Otherwise, a PUCCH configuration for unicast transmissions (e.g., PDSCHs scrambled by a UE-specific RNTI) applies. For example, a UE may be configured with a PUCCH-config IE for multicast and another PUCCH-config IE for unicast.

When separate PUCCH configurations are configured for unicast and multicast transmissions, a UE may be configured with separate K1 sets for unicast and multicast transmissions. The K1 set would have a large impact on the Type-1 HARQ-ACK codebook determination according to, for example, the pseudo code in the 3GPP specification TS38.213. When HARQ-ACK feedback for unicast and multicast transmissions is to be multiplexed in the same Type-1 HARQ-ACK codebook, an issue to be solved is how to construct the Type-1 HARQ-ACK codebook based on the separate K1 sets for unicast and multicast transmissions.

In some embodiments of the present disclosure, a solution to solve the above issue is to use the union of the K1 set for unicast and the K1 set for multicast. For a PUCCH transmission in a specific slot, a UE may determine a downlink association set for both unicast and multicast based on the union of the two K1 sets. The UE may further determine a candidate PDSCH reception occasion(s) in each slot of the downlink association set, which corresponds to each value in the union of the two K1 sets.

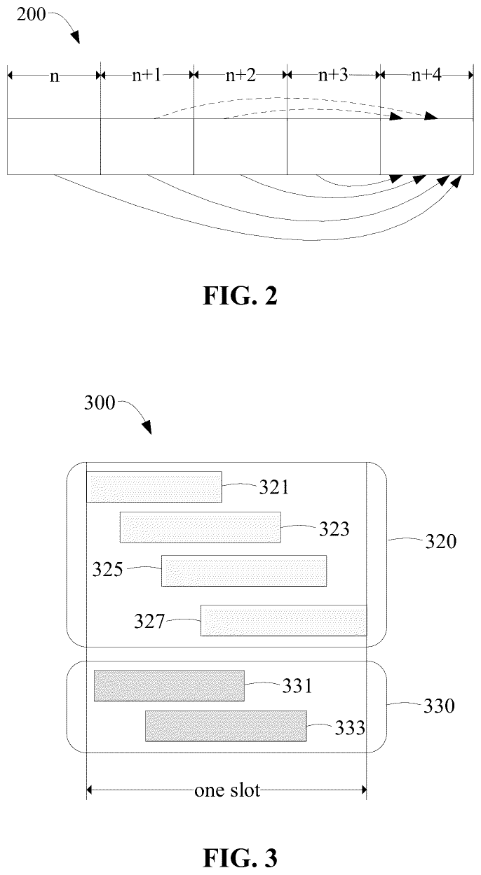

FIG. 2 illustrates a schematic diagram of a HARQ-ACK feedback transmission in accordance with some embodiments of the present disclosure.

In FIG. 2, it is assumed that the K1 set for unicast is configured as {1, 2, 3, 4} and the K1 set for multicast is configured as {2, 3}, the union of the K1 set for unicast and the K1 set for multicast is {1, 2, 3, 4}. Then, the Type-1 HARQ-ACK codebook is determined based on the union of the two K1 sets {1, 2, 3, 4}.

For example, a UE may determine a downlink association set (slot set #1) for both unicast and multicast based on the union of the two K1 sets. Assuming a PUCCH transmission in slot n+4, slot set #1 may include the slots including candidate PDSCH reception occasions for unicast PDSCHs (if transmitted) and candidate PDSCH reception occasions for multicast PDSCHs (if transmitted) to be responded with HARQ-ACK feedback (e.g., ACK or NACK) in the same Type-1 HARQ-ACK codebook in slot n+4.

For example, based on the union of the K1 sets {1, 2, 3, 4}, the UE may determine that slot set #1 includes slot n (corresponding to K1 value “4”), slot n+1 (corresponding to K1 value “3”), slot n+2 (corresponding to K1 value “2”) and slot n+3 (corresponding to K1 value “1”).

As denoted by solid arrows in FIG. 2, based on the K1 set for unicast, there are four slots (slot n, slot n+1, slot n+2 and slot n+3) which can be used for unicast PDSCH transmissions with corresponding HARQ-ACK feedback in slot n+4.

However, as denoted by dotted arrows in FIG. 2, based on the K1 set for multicast, there are actually only two slots (slot n+1 and slot n+2) which can be used for multicast PDSCH transmissions with corresponding HARQ-ACK feedback in slot n+4. As a result, the above solution based on the union of the two K1 sets would lead to unnecessary HARQ-ACK feedback overhead.

Moreover, the candidate PDSCH reception occasion(s) in a scheduled slot may depend on a time domain resource allocation (TDRA) table, which may be configured to a UE via an RRC signaling message or predefined in a standard(s). For example, the TDRA table may be configured by a higher layer parameter, e.g., pdsch-TimeDomainAllocation. In some examples, each entry of the TDRA table may include a start and length indicator value (SLIV) indicating a starting symbol and length of a scheduled transmission (e.g., PDSCH) in a slot.

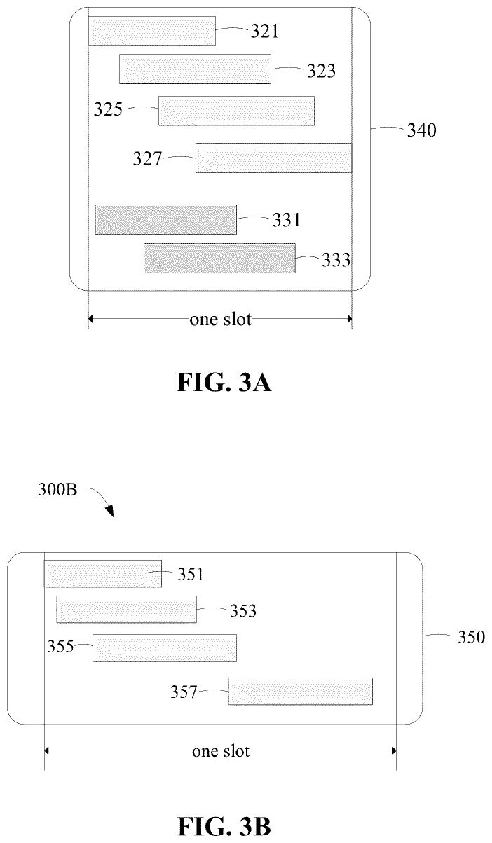

FIG. 3 illustrates an exemplary time domain resource allocation (TDRA) configuration 300 in accordance with some embodiments of the present disclosure.

A UE may be configured with a TDRA table 320 for unicast transmissions, and a TDRA table 330 for multicast transmissions. TDRA table 320 may include four SLIVs 321-327 and TDRA table 330 may include two SLIVs 331 and 333. As shown in FIG. 3, SLIVs 321-327 in the TDRA table 320 for unicast transmissions overlap with each other, which is referred to as one non-overlapped SLIV in the context of the disclosure. Accordingly, at most one PDSCH can be scheduled in a slot according to TDRA table 320. Therefore, the UE may determine that there is one candidate PDSCH reception occasion in a scheduled slot according to TDRA table 320. That is, the number of non-overlapped SLIVs in a TDRA table may denote the number of candidate PDSCH reception occasions per slot.

In some examples, the number of candidate PDSCH reception occasions per slot may be dependent on UE capability. Assuming that a UE cannot receive more than one PDSCH per slot, the UE may determine that there is only one candidate PDSCH reception occasion in a scheduled slot according to the UE's capability. For a UE not supporting receiving more than one PDSCH per slot, the UE may not be expected to be configured with more than one non-overlapped SLIV in the TDRA table.

Similarly, at most one PDSCH can be scheduled in a slot according to TDRA table 330. Therefore, the UE may determine that there is one candidate PDSCH reception occasion in a scheduled slot according to TDRA table 330.

In some embodiments of the present disclosure, construction of a Type-1 HARQ-ACK codebook may be based on the union of the TDRA table for unicast service and the TDRA table for multicast service (if they are separately configured).

FIG. 3A illustrates a TDRA table union 340 of TDRA table 320 and TDRA table 330. As shown in FIG. 3A, TDRA table union 340 includes SLIVs 321-327 from TDRA table 320 and SLIVs 331 and 333 from TDRA table 330, which overlap with each other. Accordingly, there is one non-overlapped SLIV in TDRA table union 340. Therefore, the UE may determine that there is one candidate PDSCH reception occasion in a scheduled slot (e.g., a slot in slot set #1 or slot set #2) according to TDRA table union 340.

FIG. 3B illustrates an exemplary TDRA configuration 300B in accordance with some embodiments of the present disclosure. A UE may be configured with a TDRA table 350 for multicast or unicast transmissions, which may include four SLIVs 351-357. As shown in FIG. 3B, SLIV 357 does not overlap SLIVs 351 and 353, which is referred to as two non-overlapped SLIVs in the context of the disclosure. Accordingly, the number of candidate PDSCH reception occasions in a scheduled slot according to TDRA table 350 is two, which may respectively correspond to SLIV 351 and SLIV 357 or SLIV 353 and SLIV 357.

In some examples, the number of candidate PDSCH reception occasions per slot may be dependent on UE capability. Assuming that a UE can receive two PDSCHs per slot, the UE may determine that there are two candidate PDSCH reception occasions in a scheduled slot according to the UE's capability. For a UE supporting receiving more than one PDSCH per slot, the UE can be configured with more than one non-overlapped SLIV in the TDRA table.

For a slot included in both the downlink association set for unicast transmissions and the downlink association set for multicast transmissions, when there are two or more non-overlapped SLIVs in the union of the unicast TDRA table and multicast TDRA table, an issue to be solved is how to determine the candidate PDSCH reception occasions in this slot. That is, how to determine the number of candidate PDSCH reception occasions in this slot. Since each candidate PDSCH reception occasion may correspond to a specific number of HARQ-ACK information bits (e.g., one HARQ-ACK information bit in the case of a maximum single codeword per PDSCH and no CBG-based transmission, and more than one HARQ-ACK information bit in the case of multiple-input-multiple-output (MIMO) or CBG-based retransmission), the determination of candidate PDSCH reception occasions would be relevant to the Type-1 HARQ-ACK codebook determination. In addition, the number of PDSCHs which can be received in one slot may be relevant to a UE's capability. Different UEs may have different capabilities, for example, some UEs can only receive one PDSCH per slot while some UEs can receive two PDSCHs per slot. Such UE capability should also be taken into account when generating a HARQ-ACK codebook.

Furthermore, even if the number of candidate PDSCH reception occasions for unicast and multicast is determined, another issue to be solved is how to generate the Type-1 HARQ-ACK codebook. For example, how to arrange the HARQ-ACK feedback for unicast and HARQ-ACK feedback for multicast in the Type-1 HARQ-ACK codebook to be transmitted on the same PUCCH.

For Type-1 HARQ-ACK codebook determination, yet another issue to be solved is how to generate corresponding HARQ-ACK feedback when there is only one non-overlapped SLIV in the union of a unicast TDRA table and multicast TDRA table or when the UE cannot support receiving more than one PDSCH per slot. For example, when no PDSCH is received in the slot included in both the downlink association set for unicast transmissions and the downlink association set for multicast transmissions, should a NACK bit for this slot be counted as HARQ-ACK feedback for unicast or HARQ-ACK feedback for multicast? For example, assuming that a UE is configured with separate TDRA tables for unicast and multicast as shown in FIG. 3, when the UE does not receive any PDSCH in slot n+1 as shown in FIG. 2, a NACK bit should be mapped to this slot. However, a problem lies in whether this NACK bit should be included in the HARQ-ACK codebook for unicast or the HARQ-ACK codebook for multicast.

Embodiments of the present disclosure provide solutions to solve the above issues. For example, solutions for determining the Type-1 HARQ-ACK codebook are proposed. More details on the embodiments of the present disclosure will be illustrated in the following text in combination with the appended drawings.

Although the above issues and the below solutions are described with respect to a specific network architecture or application scenario, it should be appreciated by persons skilled in the art that the above issues may exist in other specific network architectures or application scenarios, and the solutions can still solve the above issues.

A UE may receive both unicast transmissions (e.g., PDSCHs are scrambled by a UE-specific RNTI, e.g., cell-RNTI (C-RNTI), which is also referred to as “unicast PDSCHs”) and multicast transmissions (e.g., PDSCHs are scrambled by a group-common RNTI, e.g., group-RNTI (G-RNTI), which is also referred to as “multicast PDSCHs”). A UE may determine that HARQ-ACK feedback for a plurality of candidate PDSCH reception occasions are to be multiplexed in the same PUCCH in a slot (hereinafter, “slot #U1”). For example, the PUCCH may carry a HARQ-ACK codebook including HARQ-ACK information bits for the plurality of candidate PDSCH reception occasions.

The plurality of candidate PDSCH reception occasions may include a candidate PDSCH reception occasion(s) for a unicast transmission(s) (hereinafter, “candidate PDSCH reception occasions #A1”) and a candidate PDSCH reception occasion(s) for a multicast transmission(s) (hereinafter, “candidate PDSCH reception occasions #B1”). Candidate PDSCH reception occasions #A1 may be included in a downlink association set for unicast (hereinafter, “slot set #A1”). Candidate PDSCH reception occasions #B1 may be included in a downlink association set for multicast (hereinafter, “slot set #B1”).

In some embodiments of the present disclosure, slot set #A1 may be determined according to a HARQ-ACK feedback timing set (hereinafter, “K1 set #A1”) configured for a unicast transmission(s) (or candidate PDSCH reception occasions #A1). Slot set #B1 may be determined according to a HARQ-ACK feedback timing set (hereinafter, “K1 set #B1”) configured for a multicast transmission(s) (or candidate PDSCH reception occasions #B1). In some other embodiments, K1 set #A1, K1 set #B1, or both may be predefined in a standard(s).

In some embodiments of the present disclosure, for a slot (hereinafter, “slot #M1”) included in both slot set #A1 and slot set #B1, the candidate PDSCH reception occasion(s) in slot #M1 may be determined according to the union of the TDRA table (hereinafter, “TDRA table #A1”) configured for a unicast transmission(s) (or candidate PDSCH reception occasions #A1) and the TDRA table (hereinafter, “TDRA table #B1”) configured for a multicast transmission(s) (or candidate PDSCH reception occasions #B1).

For a slot only included in slot set #A1, the candidate PDSCH reception occasion(s) in this slot (e.g., candidate PDSCH reception occasion(s) in candidate PDSCH reception occasions #A1) may be determined according to TDRA table #A1. For a slot only included in slot set #B1, the candidate PDSCH reception occasion(s) in this slot (e.g., candidate PDSCH reception occasion(s) in candidate PDSCH reception occasions #B1) may be determined according to TDRA table #B1.

In some embodiments of the present disclosure, the PUCCH may carry two HARQ-ACK codebooks, for example, one (hereinafter, “HARQ-ACK codebook #A1”) for candidate PDSCH reception occasions #A1 and another (hereinafter, “HARQ-ACK codebook #B1”) for candidate PDSCH reception occasions #B1. The method for generating the two HARQ-ACK codebooks is further described in detail below.

Firstly, as stated above, for the PUCCH to be transmitted in slot #U1, slot set #A1 may be determined according to K1 set #A1, and slot set #B1 may be determined according to K1 set #B1. Then, candidate PDSCH reception occasions may be determined from the first slot to the last slot within the union of slot set #A1 and slot set #B1. For example, for a slot included only in slot set #A1, a candidate PDSCH reception occasion(s) in this slot is determined according to TDRA table #A1. The candidate PDSCH reception occasion(s) belongs to candidate PDSCH reception occasions #A1. For example, the number of candidate PDSCH reception occasions in this slot may equal the number of the non-overlapped SLIVs in TDRA table #A1. Similarly, for a slot included only in slot set #B1, a candidate PDSCH reception occasion(s) in this slot is determined according to TDRA table #B1. The candidate PDSCH reception occasion(s) belongs to candidate PDSCH reception occasions #B1.

For a slot (e.g., slot #M1) included in both slot set #A1 and slot set #B1, a candidate PDSCH reception occasion(s) in slot #M1 is determined according to the union of TDRA table #A1 and TDRA table #B1. For example, in the case that the number of non-overlapped SLIVs in the union of TDRA table #A1 and TDRA table #B1 is 1 (e.g., referring to FIG. 3A), two candidate PDSCH reception occasions may be determined in slot #M1. In other words, although a maximum of one PDSCH can be transmitted in slot #M1 in practice, two candidate PDSCH reception occasions are assumed in slot #M1.

One (hereinafter, “candidate PDSCH reception occasion #1”) of the two candidate PDSCH reception occasions belongs to candidate PDSCH reception occasions #A1, and the other (hereinafter, “candidate PDSCH reception occasion #2”) of the two candidate PDSCH reception occasions belongs to candidate PDSCH reception occasions #B1.

In some examples, the UE capability should be considered when determining the number of candidate PDSCH reception occasion(s) in a scheduled slot. For example, when a UE does not support receiving more than one PDSCH per slot, the UE may determine one candidate PDSCH reception occasion in a slot included only in slot set #A1 or slot set #B1 and two candidate PDSCH reception occasions in slot #M1. In some cases, the UE may be configured with a TDRA table according to its capability. For example, the configured TDRA table may include one non-overlapped SLIV when more than one PDSCH per slot is not supported.

After determining the candidate PDSCH reception occasions, HARQ-ACK codebook #A1 may be generated for a PDSCH on each candidate PDSCH reception occasion of candidate PDSCH reception occasions #A1. HARQ-ACK codebook #B1 may be generated for a PDSCH on each candidate PDSCH reception occasion of candidate PDSCH reception occasions #B1.

For example, if a PDSCH is received in a slot only included in slot set #A1 or slot set #B1, the UE may generate a HARQ-ACK information bit(s) for the corresponding candidate PDSCH reception occasion in this slot according to the decoding result of the PDSCH and multiplex the HARQ-ACK information bit(s) in the corresponding HARQ-ACK codebook (e.g., HARQ-ACK codebook #A1 or HARQ-ACK codebook #B1). Otherwise, if no PDSCH is received in a slot only included in slot set #A1 or slot set #B1, the UE may generate a NACK bit(s) for the corresponding candidate PDSCH reception occasion in this slot.

As understand by persons skilled in the art, the number of HARQ-ACK information bits for a single PDSCH or candidate PDSCH reception occasion may vary, for example, one in the case of a maximum single codeword per PDSCH and no CBG-based transmission, and more than one in the case of MIMO or CBG-based retransmission.

Regarding slot #M1, when only a unicast PDSCH is received in this slot, this unicast PDSCH may be assumed on candidate PDSCH reception occasion #1 and a discontinuous transmission (DTX) may be assumed on candidate PDSCH reception occasion #2. The UE may generate a HARQ-ACK information bit(s) for the unicast PDSCH on candidate PDSCH reception occasion #1 according to the decoding result of the unicast PDSCH and multiplex the HARQ-ACK information bit(s) in HARQ-ACK codebook #A1. The UE may generate a NACK bit(s) for candidate PDSCH reception occasion #2 for padding and multiplex the NACK bit(s) in HARQ-ACK codebook #B1.

When only a multicast PDSCH is received in slot #M1, this multicast PDSCH may be assumed on candidate PDSCH reception occasion #2, and a DTX may be assumed on candidate PDSCH reception occasion #1. The UE may generate a NACK bit(s) for candidate PDSCH reception occasion #1 for padding and multiplex the NACK bit(s) in HARQ-ACK codebook #A1. The UE may generate a HARQ-ACK information bit(s) for the multicast PDSCH on candidate PDSCH reception occasion #2 according to the decoding result of the multicast PDSCH and multiplex the HARQ-ACK information bit(s) in HARQ-ACK codebook #B1.

When no PDSCH (i.e., neither a unicast PDSCH nor a multicast PDSCH) is received in slot #M1, a DTX may be assumed on both candidate PDSCH reception occasions #1 and #2. The UE may generate a NACK bit(s) for candidate PDSCH reception occasion #1 for padding and multiplex the NACK bit(s) in HARQ-ACK codebook #A1. The UE may generate a NACK bit(s) for candidate PDSCH reception occasion #2 for padding and multiplex the NACK bit(s) in HARQ-ACK codebook #B1.

The UE may multiplex the HARQ-ACK information bit(s) for candidate PDSCH reception occasions #A1 in HARQ-ACK codebook #A1 and multiplex the HARQ-ACK information bit(s) for candidate PDSCH reception occasions #B1 in HARQ-ACK codebook #B1 according to various manners. For example, the multiplexing may be based on the order of the candidate PDSCH reception occasions in the time domain, e.g., an order of slot indexes of the candidate PDSCH reception occasions.

After generating the two HARQ-ACK codebooks, HARQ-ACK codebook #A1 and HARQ-ACK codebook #B1 may then be arranged into one HARQ-ACK codebook carried by the PUCCH to be transmitted in slot #U1. In some examples, HARQ-ACK codebook #A1 may be arranged in front of HARQ-ACK codebook #B1. In some other examples, HARQ-ACK codebook #B1 may be arranged in front of HARQ-ACK codebook #B1.

In this way, regardless of whether a PDSCH is received or not, the codebook sizes of HARQ-ACK codebook #A1 and HARQ-ACK codebook #B1 are not changed, which would avoid any misunderstanding between the UE and the BS on the HARQ-ACK codebook.

Referring back to FIG. 2, based on the configured K1 set {1, 2, 3, 4} for unicast, a UE may determine that slot set #A1 for a PUCCH in slot n+4 includes slot n, slot n+1, slot n+2, and slot n+3. Based on the configured K1 set {2, 3} for multicast, the UE may determine that slot set #B1 for the PUCCH in slot n+4 includes slot n+1 and slot n+2. The union of slot set #A1 and slot set #B1 thus includes slot n, slot n+1, slot n+2, and slot n+3, wherein slot n+1 and slot n+2 are included in both slot set #A1 and slot set #B1.

From slot n to slot n+3 in the union of slot sets, the candidate PDSCH reception occasions in slot n and slot n+3 are determined according to TDRA table #A1 (e.g., TDRA table 320 in FIG. 3), the candidate PDSCH reception occasions in slot n+1 and slot n+2 are determined according to the union (e.g., TDRA table union 340 in FIG. 3A) of TDRA table #A1 and TDRA table #B1 (e.g., TDRA table 330 in FIG. 3). For example, since one non-overlapped SLIV is included in TDRA table 320, a single candidate PDSCH reception occasion may be determined for each of slot n and slot n+3 in slot set #A1. Since one non-overlapped SLIV is included in TDRA table union 340, two candidate PDSCH reception occasions may be determined for each of slot n+1 and slot n+2. One of the two candidate PDSCH reception occasions for slot n+1 (or slot n+2) belongs to slot set #A1 and the other of the two candidate PDSCH reception occasions for slot n+1 (or slot n+2) belongs to slot set #B1.

For example, assuming a maximum of a single transport block (TB) per a unicast PDSCH and multicast PDSCH, HARQ-ACK codebook #A1 may be generated as {a0, a1, a2, a3}, where “a0”, “a1”, “a2” and “a3” are ACK or NACK bits corresponding to slot n, slot n+1, slot n+2, and slot n+3, respectively. HARQ-ACK codebook #B1 may be generated as {b0, b1}, where “b0” and “b1” are ACK or NACK bits corresponding to slot n+1 and slot n+2, respectively. The two codebooks are then concatenated, for example, HARQ-ACK codebook #A1 is placed firstly then followed by HARQ-ACK codebook #B1, or vice versa. For example, the two HARQ-ACK codebooks may be concatenated as {a0, a1, a2, a3, b0, b1}, which is transmitted in the PUCCH in slot n+4.

Compared to the solution based on the union of the K1 set for unicast and the K1 set for multicast, the above solution would not introduce unnecessary signaling overhead and would reduce the size of the Type-1 HARQ-ACK codebook.

In some embodiments of the present disclosure, instead of generating separate HARQ-ACK codebooks for unicast and multicast transmissions, HARQ-ACK feedback for unicast and multicast transmissions may be arranged in a single HARQ-ACK codebook.

In some examples, the HARQ-ACK information bit(s) for each candidate PDSCH reception occasion may be generated and then concatenated according to the order (e.g., ascending order or descending order) of the candidate PDSCH reception occasions in the time domain. For example, the HARQ-ACK information bits for the candidate PDSCH reception occasions may be arranged according to the order (e.g., ascending order or descending order) of slot indexes of the candidate PDSCH reception occasions. For instance, referring back to FIG. 2, the HARQ-ACK information bits for the candidate PDSCH reception occasions in slots n to n+3 may be arranged according to the ascending order of slot indexes n to n+3.

In some other examples, the HARQ-ACK information bits for the candidate PDSCH reception occasions per slot may be arranged according to the predefined rules. For example, the HARQ-ACK information bits for candidate unicast PDSCH reception occasions may be arranged firstly then followed by the HARQ-ACK information bits for candidate multicast PDSCH reception occasions; or vice versa.

For a slot (e.g., slot #M1) included in both a downlink association set for unicast (e.g., slot set #A1) and a downlink association set for multicast (e.g., slot set #B1), the HARQ-ACK information bit(s) for the candidate unicast PDSCH reception occasion may be placed firstly and then followed by the HARQ-ACK information bit(s) for the candidate multicast PDSCH reception occasion, or vice versa.

The method for generating the single HARQ-ACK codebook is further described in detail below.

Firstly, as stated above, for the PUCCH to be transmitted in slot #U1, slot set #A1 may be determined according to K1 set #A1, and slot set #B1 may be determined according to K1 set #B1. Then, candidate PDSCH reception occasions may be determined from the first slot to the last slot within the union of slot set #A1 and slot set #B1. For example, for a slot included only in slot set #A1, a candidate PDSCH reception occasion(s) in this slot is determined according to TDRA table #A1. The candidate PDSCH reception occasion(s) belongs to candidate PDSCH reception occasions #A1. For example, the number of candidate PDSCH reception occasions in this slot may equal the number of the non-overlapped SLIVs in TDRA table #A1. Similarly, for a slot included only in slot set #B1, a candidate PDSCH reception occasion(s) in this slot is determined according to TDRA table #B1. The candidate PDSCH reception occasion(s) belongs to candidate PDSCH reception occasions #B1.

In some examples, the UE capability should be considered when determining the number of candidate PDSCH reception occasion(s) in a scheduled slot. For example, when a UE does not support receiving more than one PDSCH per slot, the UE may determine one candidate PDSCH reception occasion in a slot included only in slot set #A1 or slot set #B1, regardless of the number of the non-overlapped SLIVs in the corresponding TDRA table. In some cases, the UE may be configured with a TDRA table according to its capability. For example, the configured TDRA table may include one non-overlapped SLIV when more than one PDSCH per slot is not supported.

For a slot (e.g., slot #M1) included in both slot set #A1 and slot set #B1, a candidate PDSCH reception occasion(s) in slot #M1 may be determined according to the union of TDRA table #A1 and TDRA table #B1. Various methods may be employed to determine the candidate PDSCH reception occasion(s) in slot #M1, and will be described in detail in the following text.

After determining the candidate PDSCH reception occasions, HARQ-ACK information bit(s) for each of the candidate PDSCH reception occasions within each slot of slot set #A1 and slot set #B1 may be generated. In other words, HARQ-ACK information bit(s) for each of candidate PDSCH reception occasions #A1 and #B1 may be generated.

For example, when a PDSCH is received in a slot only included in slot set #A1 or slot set #B1, the UE may generate a HARQ-ACK information bit(s) for the corresponding candidate PDSCH reception occasion in this slot according to the decoding result of the PDSCH and multiplex the HARQ-ACK information bit(s) in the HARQ-ACK codebook according to the time order. Otherwise, if no PDSCH is received in the slot only included in slot set #A1 or slot set #B1, the UE may generate a NACK bit(s) for the corresponding candidate PDSCH reception occasion in this slot.

The generation of HARQ-ACK feedback for a slot (e.g., slot #M1) included in both slot set #A1 and slot set #B1 will be described in detail in the following text along with the determination of the candidate PDSCH reception occasion(s) in this slot.

Then, the HARQ-ACK information bits for candidate PDSCH reception occasions #A1 and #B1 may be arranged according to a time order (e.g., ascending order or descending order) of candidate PDSCH reception occasions #A1 and #B1.

The determination of the candidate PDSCH reception occasion(s) in slot #M1 according to the union of TDRA tables will now be described.

In some embodiments of the present disclosure, in the case that the number of non-overlapped SLIVs in the union of TDRA table #A1 and TDRA table #B1 is 1 (e.g., referring to FIG. 3A), two candidate PDSCH reception occasions may be determined in slot #M1. In other words, although a maximum of one PDSCH can be transmitted in slot #M1 in practice, two candidate PDSCH reception occasions are assumed in slot #M1. One (e.g., candidate PDSCH reception occasion #1) of the two candidate PDSCH reception occasions belongs to candidate PDSCH reception occasions #A1, and the other (e.g., candidate PDSCH reception occasion #2) of the two candidate PDSCH reception occasions belongs to candidate PDSCH reception occasions #B1.

In some examples, the UE capability should be considered when determining the number of candidate PDSCH reception occasion(s) in a scheduled slot. For example, when a UE does not support receiving more than one PDSCH per slot, the UE may determine two candidate PDSCH reception occasion in slot #M1. In some cases, the UE may be configured with a TDRA table according to its capability.

When only a unicast PDSCH is received in slot #M1, this unicast PDSCH may be assumed on candidate PDSCH reception occasion #1 and a discontinuous transmission (DTX) may be assumed on candidate PDSCH reception occasion #2. The UE may generate a HARQ-ACK information bit(s) for the unicast PDSCH on candidate PDSCH reception occasion #1 according to the decoding result of the unicast PDSCH. The UE may generate a NACK bit(s) for candidate PDSCH reception occasion #2 for padding.

When only a multicast PDSCH is received in slot #M1, this multicast PDSCH may be assumed on candidate PDSCH reception occasion #2, and a DTX may be assumed on candidate PDSCH reception occasion #1. The UE may generate a NACK bit(s) for candidate PDSCH reception occasion #1 for padding. The UE may generate a HARQ-ACK information bit(s) for the multicast PDSCH on candidate PDSCH reception occasion #2 according to the decoding result of the multicast PDSCH.

When no PDSCH (i.e., neither a unicast PDSCH nor a multicast PDSCH) is received in slot #M1, a DTX may be assumed on both candidate PDSCH reception occasions #1 and #2. The UE may generate a NACK bit(s) for candidate PDSCH reception occasion #1 for padding and a NACK bit(s) for candidate PDSCH reception occasion #2 for padding.

Then, as described above, in some examples, the HARQ-ACK information bits for all the candidate PDSCH reception occasions may be arranged according to an order of the candidate PDSCH reception occasions in the time domain. Since slot #M1 includes two candidate PDSCH reception occasions, that is, candidate PDSCH reception occasions #1 and #2 have the same order in the time domain, in some examples, HARQ-ACK information bit(s) for candidate PDSCH reception occasion #1 may be placed firstly and then followed by the HARQ-ACK information bit(s) for candidate PDSCH reception occasion #2. In some other examples, HARQ-ACK information bit(s) for candidate PDSCH reception occasion #2 may be placed firstly and then followed by the HARQ-ACK information bit(s) for candidate PDSCH reception occasion #1.

In some other examples, as described above, the HARQ-ACK information bits for the candidate PDSCH reception occasions per slot may be arranged according to the predefined rules.

In this way, regardless of whether a PDSCH is received or not, the codebook sizes of the HARQ-ACK codebook for both unicast and multicast transmissions are not changed, which would avoid any misunderstanding between the UE and the BS on the HARQ-ACK codebook.

Referring back to FIG. 2, based on the configured K1 set {1, 2, 3, 4} for unicast, a UE may determine that slot set #A1 for a PUCCH in slot n+4 includes slot n, slot n+1, slot n+2, and slot n+3. Based on the configured K1 set {2, 3} for multicast, the UE may determine that slot set #B1 for the PUCCH in slot n+4 includes slot n+1 and slot n+2. The union of slot set #A1 and slot set #B1 thus includes slot n, slot n+1, slot n+2, and slot n+3, wherein slot n+1 and slot n+2 are included in both slot set #A1 and slot set #B1.

From slot n to slot n+3 in the union of slot sets, the candidate PDSCH reception occasions in slot n and slot n+3 are determined according to TDRA table #A1 (e.g., TDRA table 320 in FIG. 3), the candidate PDSCH reception occasions in slot n+1 and slot n+2 are determined according to the union (e.g., TDRA table union 340 in FIG. 3A) of TDRA table #A1 and TDRA table #B1 (e.g., TDRA table 330 in FIG. 3).

For example, since one non-overlapped SLIV is included in TDRA table 320, a single candidate PDSCH reception occasion may be determined for each of slot n and slot n+3 in slot set #A1. Since one non-overlapped SLIV is included in TDRA table union 340, two candidate PDSCH reception occasions may be determined for each of slot n+1 and slot n+2. One of the two candidate PDSCH reception occasions for slot n+1 (or slot n+2) belongs to slot set #A1 and the other of the two candidate PDSCH reception occasions for slot n+1 (or slot n+2) belongs to slot set #B1.

Assuming a maximum of a single transport block (TB) per a unicast PDSCH and multicast PDSCH, according to the ascending order of all candidate PDSCH reception occasions in the time domain, a single HARQ-ACK codebook for both unicast and multicast PDSCHs may be generated as {a0, a1/NACK, b0/NACK, a2/NACK, b1/NACK, a3}.

In the HARQ-ACK codebook, “a0” and “a3” are ACK or NACK bits corresponding to unicast PDSCHs in slot n, and slot n+3, respectively. “a1” in “a1/NACK” denotes an ACK or NACK bit(s) corresponding to a unicast PDSCH in slot n+1 when the unicast PDSCH is received and “NACK” in “a1/NACK” denotes a NACK bit(s) for padding when the unicast PDSCH is not received in slot n+1. Similarly, “b0” in “b0/NACK” denotes an ACK or NACK bit(s) corresponding to a multicast PDSCH in slot n+1 when the multicast PDSCH is received and “NACK” in “b0/NACK” denotes a NACK bit(s) for padding when the multicast PDSCH is not received in slot n+1. “a2” in “a2/NACK” denotes an ACK or NACK bit(s) corresponding to a unicast PDSCH in slot n+2 when the unicast PDSCH is received and “NACK” in “a2/NACK” denotes a NACK bit(s) for padding when the unicast PDSCH is not received in slot n+2. “b1” in “b1/NACK” denotes an ACK or NACK bit(s) corresponding to a multicast PDSCH in slot n+2 when the multicast PDSCH is received and “NACK” in “b1/NACK” denotes a NACK bit(s) for padding when the multicast PDSCH is not received in slot n+2.

In some other examples, according to a predefined rule, for example, the HARQ-ACK information bits for candidate unicast PDSCH reception occasions is arranged firstly then followed by the HARQ-ACK information bits for candidate multicast PDSCH reception occasions, the single HARQ-ACK codebook for both unicast and multicast PDSCHs may be generated as {a0, a1/NACK, a2/NACK, a3, b0/NACK, b1/NACK}.

Compared to the solution based on the union of the K1 set for unicast and the K1 set for multicast, the above solution would not introduce unnecessary signaling overhead and would reduce the size of the Type-1 HARQ-ACK codebook.

In some embodiments of the present disclosure, in the case that the number of non-overlapped SLIVs in the union of TDRA table #A1 and TDRA table #B1 is 1 (e.g., referring to FIG. 3A), a single candidate PDSCH reception occasion may be determined in slot #M1.

In some examples, the UE capability should be considered when determining the number of candidate PDSCH reception occasion(s) in a scheduled slot. For example, when a UE does not support receiving more than one PDSCH per slot, the UE may determine a single candidate PDSCH reception occasion in slot #M1. In some cases, the UE may be configured with a TDRA table according to its capability.

This single candidate PDSCH reception occasion may be assumed for either unicast or multicast. That is, it may be included in either candidate PDSCH reception occasions #A1 or candidate PDSCH reception occasions #B1.

When only a unicast PDSCH is received in slot #M1, this unicast PDSCH may be assumed on the single candidate PDSCH reception occasion. The UE may generate a HARQ-ACK information bit(s) for the unicast PDSCH on the single candidate PDSCH reception occasion according to the decoding result of the unicast PDSCH.

When only a multicast PDSCH is received in slot #M1, this multicast PDSCH may be assumed on the single candidate PDSCH reception occasion. The UE may generate a HARQ-ACK information bit(s) for the multicast PDSCH on the single candidate PDSCH reception occasion according to the decoding result of the multicast PDSCH.

When no PDSCH (i.e., neither a unicast PDSCH nor a multicast PDSCH) is received in slot #M1, the UE may generate a NACK bit(s) for the single candidate PDSCH reception occasion for padding.

Then, as described above, the HARQ-ACK information bits for all the candidate PDSCH reception occasions may be arranged according to an order of the candidate PDSCH reception occasions in the time domain.

In this way, regardless of whether a PDSCH is received or not, the codebook size of the HARQ-ACK codebook for both unicast and multicast transmissions is not changed, which would avoid any misunderstanding between the UE and the BS on the HARQ-ACK codebook.

Referring back to FIG. 2, based on the configured K1 set {1, 2, 3, 4} for unicast, a UE may determine that slot set #A1 for a PUCCH in slot n+4 includes slot n, slot n+1, slot n+2, and slot n+3. Based on the configured K1 set {2, 3} for multicast, the UE may determine that slot set #B1 for the PUCCH in slot n+4 includes slot n+1 and slot n+2. The union of slot set #A1 and slot set #B1 thus includes slot n, slot n+1, slot n+2, and slot n+3, wherein slot n+1 and slot n+2 are included in both slot set #A1 and slot set #B1.

From slot n to slot n+3 in the union of slot sets, the candidate PDSCH reception occasions in slot n and slot n+3 are determined according to TDRA table #A1 (e.g., TDRA table 320 in FIG. 3), the candidate PDSCH reception occasions in slot n+1 and slot n+2 are determined according to the union (e.g., TDRA table union 340 in FIG. 3A) of TDRA table #A1 and TDRA table #B1 (e.g., TDRA table 330 in FIG. 3).

For example, since one non-overlapped SLIV is included in TDRA table 320, a single candidate PDSCH reception occasion may be determined for each of slot n and slot n+3 in slot set #A1. Since one non-overlapped SLIV is included in TDRA table union 340, a single candidate PDSCH reception occasion may be determined for each of slot n+1 and slot n+2.

Assuming a maximum of a single transport block (TB) per a unicast PDSCH and multicast PDSCH, according to the ascending order of all candidate PDSCH reception occasions in the time domain, a single HARQ-ACK codebook for both unicast and multicast PDSCHs may be generated as {a0, a1/b0/NACK, a2/b1/NACK, a3}.

In the HARQ-ACK codebook, “a0” and “a3” are ACK or NACK bits corresponding to unicast PDSCHs in slot n, and slot n+3, respectively. “a1” in “a1/b0/NACK” denotes an ACK or NACK bit(s) corresponding to a unicast PDSCH in slot n+1 when the unicast PDSCH is received, “b0” in “a1/b0/NACK” denotes an ACK or NACK bit(s) corresponding to a multicast PDSCH in slot n+1 when the multicast PDSCH is received, and “NACK” in “a1/b0/NACK” denotes a NACK bit(s) for padding when neither the unicast PDSCH nor multicast PDSCH is received in slot n+1. Similarly, “a2” in “a2/b1/NACK” denotes an ACK or NACK bit(s) corresponding to a unicast PDSCH in slot n+2 when the unicast PDSCH is received, “b1” in “a2/b1/NACK” denotes an ACK or NACK bit(s) corresponding to a multicast PDSCH in slot n+2 when the multicast PDSCH is received, and “NACK” in “a2/b1/NACK” denotes a NACK bit(s) for padding when neither the unicast PDSCH nor multicast PDSCH is received in slot n+2.

Compared to the solution based on the union of the K1 set for unicast and the K1 set for multicast, the above solution would not introduce unnecessary signaling overhead and would reduce the size of the Type-1 HARQ-ACK codebook.

In some embodiments of the present disclosure, the union of K1 set for a unicast transmission(s) and K1 set for a multicast transmission(s) and the union of the TDRA table for a unicast transmission(s) and the TDRA table for a multicast transmission(s) may not be employed.

For example, the plurality of candidate PDSCH reception occasions with HARQ-ACK feedback to be multiplexed in the same PUCCH in a slot (e.g., “slot #U1”) may include a candidate PDSCH reception occasion(s) for a unicast transmission(s) (hereinafter, “candidate PDSCH reception occasions #A2”) and a candidate PDSCH reception occasion(s) for a multicast transmission(s) (hereinafter, “candidate PDSCH reception occasions #B2”). Candidate PDSCH reception occasions #A2 may be included in a downlink association set for unicast (hereinafter, “slot set #A2”). Candidate PDSCH reception occasions #B2 may be included in a downlink association set for multicast (hereinafter, “slot set #B2”).

In some embodiments of the present disclosure, slot set #A2 may be determined according to a HARQ-ACK feedback timing set (hereinafter, “K1 set #A2”) for a unicast transmission(s) (or candidate PDSCH reception occasions #A2). Slot set #B2 may be determined according to a HARQ-ACK feedback timing set (hereinafter, “K1 set #B2”) configured for a multicast transmission(s) (or candidate PDSCH reception occasions #B2).

In each slot of slot set #A2, the candidate PDSCH reception occasion(s) is determined according to the TDRA table (hereinafter, “TDRA table #A2”) for a unicast transmission(s) (or candidate PDSCH reception occasions #A2). In each slot of slot set #B2, the candidate PDSCH reception occasion(s) is determined according to the TDRA table (hereinafter, “TDRA table #B2”) for a multicast transmission(s) (or candidate PDSCH reception occasions #B2).

In some examples, the UE capability should be considered when determining the number of candidate PDSCH reception occasion(s) in a scheduled slot. For example, when a UE does not support receiving more than one PDSCH per slot, the UE may determine one candidate PDSCH reception occasion in a scheduled slot. In some cases, the UE may be configured with a TDRA table according to its capability.

A HARQ-ACK codebook for unicast (hereinafter, “HARQ-ACK codebook #A2”) may be generated according to K1 set #A2 and TDRA table #A2. A HARQ-ACK codebook for multicast (hereinafter, “HARQ-ACK codebook #B2”) may be generated according to K1 set #B2 and TDRA table #B2. HARQ-ACK codebook #A2 and HARQ-ACK codebook #B2 may then be arranged into one HARQ-ACK codebook carried by the PUCCH to be transmitted in slot #U1. In some examples, HARQ-ACK codebook #A2 may be arranged in front of HARQ-ACK codebook #B2. In some other examples, HARQ-ACK codebook #B2 may be arranged in front of HARQ-ACK codebook #B2.

The method for generating the two HARQ-ACK codebooks is further described in detail below.

Firstly, for the PUCCH to be transmitted in slot #U1, slot set #A2 may be determined according to K1 set #A2. Candidate PDSCH reception occasions #A2 in slot set #A2 may be determined according to TDRA table #A2. HARQ-ACK codebook #A2 may be generated for each of candidate PDSCH reception occasions #A2.

Similarly, for the PUCCH to be transmitted in slot #U1, slot set #B2 may be determined according to K1 set #B2. Candidate PDSCH reception occasions #B2 in slot set #B2 may be determined according to TDRA table #B2. HARQ-ACK codebook #B2 may be generated for each of candidate PDSCH reception occasions #B2.

Then, HARQ-ACK codebook #A2 and HARQ-ACK codebook #B2 may be concatenated, for example, HARQ-ACK codebook #A2 is placed firstly then followed by HARQ-ACK codebook #B2, or vice versa, to be transmitted on the PUCCH in slot #U1.

Referring back to FIG. 2, based on the configured K1 set {1, 2, 3, 4} for unicast, a UE may determine that slot set #A2 for a PUCCH in slot n+4 includes slot n, slot n+1, slot n+2, and slot n+3. Based on the configured K1 set {2, 3} for multicast, the UE may determine that slot set #B2 for the PUCCH in slot n+4 includes slot n+1 and slot n+2.

The candidate PDSCH reception occasion(s) for each slot in slot set #A2 may be determined according to TDRA table #A2 (e.g., TDRA table 320 in FIG. 3). The candidate PDSCH reception occasion(s) for each slot in slot set #B2 may be determined according to TDRA table #B2 (e.g., TDRA table 330 in FIG. 3).

For example, since one non-overlapped SLIV is included in TDRA table 320, a single candidate PDSCH reception occasion may be determined for each of slot n, slot n+1, slot n+2, and slot n+3 in slot set #A2. Since one non-overlapped SLIV is included in TDRA table 330, a single candidate PDSCH reception occasion may be determined for each of slot n+1 and slot n+2 in slot set #B2.

Assuming a maximum of a single transport block (TB) per a unicast PDSCH and multicast PDSCH, according to the ascending order of all candidate PDSCH reception occasions in the time domain, HARQ-ACK codebook #A2 may be generated as {a0, a1, a2, a3}, where “a0”, “a1”, “a2” and “a3” are ACK or NACK bits corresponding to slot n, slot n+1, slot n+2, and slot n+3, respectively. HARQ-ACK codebook #B2 may be generated as {b0, b1}, where “b0” and “b1” are ACK or NACK bits corresponding to slot n+1 and slot n+2, respectively. The two codebooks are then concatenated, for example, HARQ-ACK codebook #A2 is placed firstly then followed by HARQ-ACK codebook #B2, or vice versa. For example, the two HARQ-ACK codebooks may be concatenated as {a0, a1, a2, a3, b0, b1}, which is transmitted in the PUCCH in slot n+4.

Compared to the solution based on the union of the K1 set for unicast and the K1 set for multicast, the above solution would not introduce unnecessary signaling overhead and would reduce the size of the Type-1 HARQ-ACK codebook.

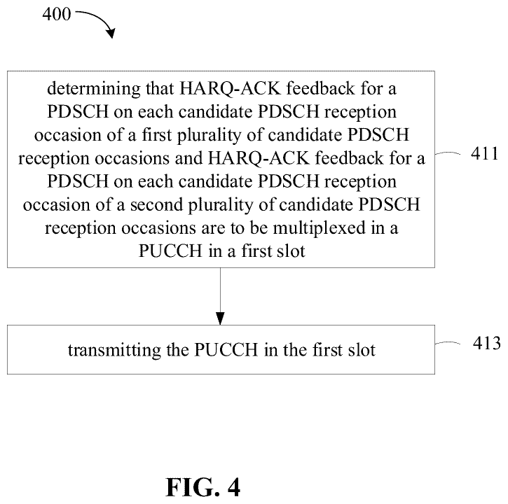

FIG. 4 illustrates a flow chart of an exemplary procedure 400 for wireless communications in accordance with some embodiments of the present disclosure. Details described in all of the foregoing embodiments of the present disclosure are applicable for the embodiments shown in FIG. 4. In some examples, the procedure may be performed by a UE, for example, UE 101 in FIG. 1.

Referring to FIG. 4, in operation 411, a UE may determine that HARQ-ACK feedback for a PDSCH on each candidate PDSCH reception occasion of a first plurality of candidate PDSCH reception occasions (e.g., candidate PDSCH reception occasions #A1 or candidate PDSCH reception occasions #A2) and HARQ-ACK feedback for a PDSCH on each candidate PDSCH reception occasion of a second plurality of candidate PDSCH reception occasions (e.g., candidate PDSCH reception occasions #B1 or candidate PDSCH reception occasions #B2) are to be multiplexed in a PUCCH in a first slot (e.g., slot #U1 or slot n+4 in FIG. 2). The PDSCH on each candidate PDSCH reception occasion of the first plurality of candidate PDSCH reception occasions may be scrambled by a first RNTI specific to the UE (e.g., C-RNTI) and the PDSCH on each candidate PDSCH reception occasion of the second plurality of PDSCHs may be scrambled by a second RNTI common to a group of UEs including the UE (e.g., G-RNTI for multicast).

In operation 413, the UE may transmit the PUCCH in the first slot.

In some embodiments of the present disclosure, the first plurality of candidate PDSCH reception occasions may be included in a first set of slots (e.g., slot set #A1 or slot set #A2) and the second plurality of candidate PDSCH reception occasions are included in a second set of slots (e.g., slot set #B1 or slot set #B2).

The first set of slots may be determined based on a first HARQ-ACK feedback timing set (e.g., K1 set #A1 or K1 set #A2) configured for the first plurality of candidate PDSCH reception occasions and the second set of slots is determined based on a second HARQ-ACK feedback timing set (e.g., K1 set #B1 or K1 set #B2) configured for the second plurality of candidate PDSCH reception occasions.

In response to a slot being included only in the first set of slots, the UE may determine a candidate PDSCH reception occasion of the first plurality of candidate PDSCH reception occasions in the slot according to a first TDRA table (e.g., TDRA table #A1 or TDRA table #A2) configured for the first plurality of candidate PDSCH reception occasions. In response to a slot being included only in the second set of slots, the UE may determine a candidate PDSCH reception occasion of the second plurality of candidate PDSCH reception occasions in the slot according to a second TDRA table (e.g., TDRA table #B1 or TDRA table #B2) configured for the second plurality of candidate PDSCH reception occasions. For example, referring back to FIG. 3, according to TDRA table 320 or TDRA table 330, one candidate PDSCH reception occasion may be determined for the slot. Referring to FIG. 3B, according to TDRA table 350, two candidate PDSCH reception occasions may be determined for the slot.

Referring to FIG. 4, in response to a slot being included in both the first and second sets of slots, the UE may determine a candidate PDSCH reception occasion in the slot according to a union of the first and second TDRA tables (e.g., TDRA table union 340 in FIG. 3A).

In some embodiments of the present disclosure, the UE may determine a candidate PDSCH reception occasion according to a union of the first and second TDRA tables by: in response to a number of non-overlapped SLIVs in the union of the first and second TDRA tables being equal to 1 or the UE supporting receiving a maximum of one PDSCH per slot, determining two candidate PDSCH reception occasions in the slot (e.g., slot #M1) included in both the first and second sets of slots. For example, referring back to FIG. 3A, according to TDRA table union 340, two candidate PDSCH reception occasion may be determined for the slot.

One (e.g., candidate PDSCH reception occasion #1) of the two candidate PDSCH reception occasions may be included in the first plurality of candidate PDSCH reception occasions and the other (e.g., candidate PDSCH reception occasion #2) of two candidate PDSCH reception occasions may be included in the second plurality of candidate PDSCH reception occasions.

In some embodiments of the present disclosure, the UE may determine a candidate PDSCH reception occasion according to a union of the first and second TDRA tables by: in response to a number of non-overlapped SLIVs in the union of the first and second TDRA tables being equal to 1 or the UE supporting receiving a maximum of one PDSCH per slot, determining a single candidate PDSCH reception occasion in the slot (e.g., slot #M1) included in both the first and second sets of slots. For example, referring back to FIG. 3A, according to TDRA table union 340, one candidate PDSCH reception occasion may be determined for the slot. The single candidate PDSCH reception occasion may be included in either the first plurality of candidate PDSCH reception occasions or the second plurality of candidate PDSCH reception occasions.

The UE may generate a HARQ-ACK information bit(s) for the single candidate PDSCH reception occasion in response to receiving a single PDSCH scrambled by the first RNTI in the slot included in both the first and second sets of slots. The UE may generate a HARQ-ACK information bit(s) for the single candidate PDSCH reception occasion in response to receiving a single PDSCH scrambled by the second RNTI in the slot included in both the first and second sets of slots. The UE may generate a NACK) bit(s) for the single candidate PDSCH reception occasion in response to not receiving a PDSCH in the slot included in both the first and second sets of slots.

In some embodiments of the present disclosure, the PUCCH may carry a first HARQ-ACK codebook (e.g., HARQ-ACK codebook #A1 or HARQ-ACK codebook #A2) for the first plurality of candidate PDSCH reception occasions and a second HARQ-ACK codebook (e.g., HARQ-ACK codebook #B1 or HARQ-ACK codebook #B2) for the second plurality of candidate PDSCH reception occasions. In some examples, the first HARQ-ACK codebook may be arranged in front of the second HARQ-ACK codebook in the PUCCH. In some other examples, the second HARQ-ACK codebook may be arranged in front of the first HARQ-ACK codebook in the PUCCH.

In some embodiments of the present disclosure, the UE may generate a HARQ-ACK information bit(s) for each candidate PDSCH reception occasion in either the first plurality of candidate PDSCH reception occasions or the second plurality of candidate PDSCH reception occasions. The UE may further arrange HARQ-ACK information bits for the candidate PDSCH reception occasions among the first set of slots and the second set of slots in a HARQ-ACK codebook according to an order (e.g., an ascending or descending order) of the candidate PDSCH reception occasions in the time domain or a predefined rule. The HARQ-ACK codebook may be carried in the PUCCH.

In some examples, the UE may arrange the HARQ-ACK information bits for the candidate PDSCH reception occasions according to the order of the candidate PDSCH reception occasions in the time domain by: arranging the HARQ-ACK information bits for the candidate PDSCH reception occasions according to an order of slot indexes of the candidate PDSCH reception occasions.

In some embodiments of the present disclosure, in response to a slot included in the union of the first set of slots and the second set of slots including a first candidate PDSCH reception occasion (e.g., candidate PDSCH reception occasion #1) in the first plurality of candidate PDSCH reception occasions and a second candidate PDSCH reception occasion (e.g., candidate PDSCH reception occasion #2) in the second plurality of candidate PDSCH reception occasions, the HARQ-ACK information bit(s) for the first candidate PDSCH reception occasion may be arranged in front of the HARQ-ACK information bit(s) for the second candidate PDSCH reception occasion in the HARQ-ACK codebook. As an alternative, the HARQ-ACK information bit(s) for the second candidate PDSCH reception occasion may be arranged in front of the HARQ-ACK information bit(s) for the first candidate PDSCH reception occasion in the HARQ-ACK codebook.

In some embodiments of the present disclosure, the UE may determine a candidate PDSCH reception occasion of the first plurality of candidate PDSCH reception occasions (e.g., candidate PDSCH reception occasions #A2) in each of the first set of slots (e.g., slot set #A2) according to non-overlapped SLIVs in a first TDRA table (e.g., TDRA table #A2) configured for the first plurality of candidate PDSCH reception occasions.

The UE may further determine a candidate PDSCH reception occasion of the second plurality of candidate PDSCH reception occasions (e.g., candidate PDSCH reception occasions #B2) in each of the second set of slots (e.g., slot set #B2) according to non-overlapped SLIVs in a second TDRA table (e.g., TDRA table #B2) configured for the second plurality of candidate PDSCH reception occasions.

The number of candidate PDSCH reception occasions in a slot of the first set of slots may be equal to a number of non-overlapped SLIVs in the first TDRA table. The number of candidate PDSCH reception occasions in a slot of the second set of slots may be equal to a number of non-overlapped SLIVs in the second TDRA table.

It should be appreciated by persons skilled in the art that the sequence of the operations in exemplary procedure 400 may be changed and some of the operations in exemplary procedure 400 may be eliminated or modified, without departing from the spirit and scope of the disclosure.

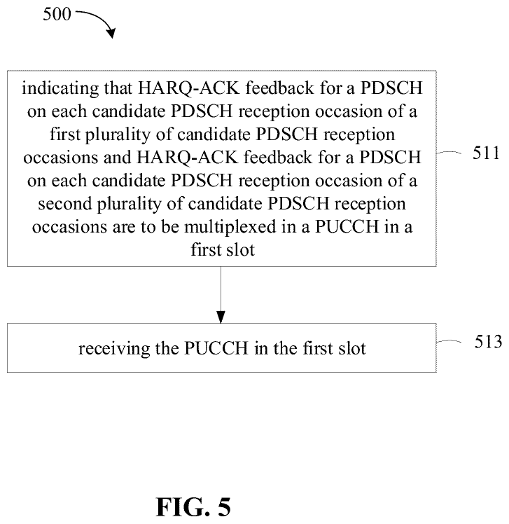

FIG. 5 illustrates a flow chart of an exemplary procedure 500 for wireless communications in accordance with some embodiments of the present disclosure. Details described in all of the foregoing embodiments of the present disclosure are applicable for the embodiments shown in FIG. 5. In some examples, the procedure may be performed by a BS, for example, BS 102 in FIG. 1.

Referring to FIG. 5, in operation 511, a BS may indicate that HARQ-ACK feedback for a PDSCH on each candidate PDSCH reception occasion of a first plurality of candidate PDSCH reception occasions (e.g., candidate PDSCH reception occasions #A1 or candidate PDSCH reception occasions #A2) and HARQ-ACK feedback for a PDSCH on each candidate PDSCH reception occasion of a second plurality of candidate PDSCH reception occasions (e.g., candidate PDSCH reception occasions #B1 or candidate PDSCH reception occasions #B2) are to be multiplexed in a PUCCH in a first slot (e.g., slot #U1 or slot n+4 in FIG. 2). The PDSCH on each candidate PDSCH reception occasion of the first plurality of candidate PDSCH reception occasions may be scrambled by a first RNTI specific to a UE (e.g., C-RNTI) and the PDSCH on each candidate PDSCH reception occasion of the second plurality of PDSCHs may be scrambled by a second RNTI common to a group of UEs including the UE (e.g., G-RNTI for multicast).

In operation 513, the BS may receive the PUCCH in the first slot.

In some embodiments of the present disclosure, the first plurality of candidate PDSCH reception occasions may be included in a first set of slots (e.g., slot set #A1 or slot set #A2) and the second plurality of candidate PDSCH reception occasions are included in a second set of slots (e.g., slot set #B1 or slot set #B2).

The first set of slots may be determined based on a first HARQ-ACK feedback timing set (e.g., K1 set #A1 or K1 set #A2) configured for the first plurality of candidate PDSCH reception occasions and the second set of slots is determined based on a second HARQ-ACK feedback timing set (e.g., K1 set #B1 or K1 set #B2) configured for the second plurality of candidate PDSCH reception occasions.

In response to a slot being included only in the first set of slots, the BS may determine a candidate PDSCH reception occasion of the first plurality of candidate PDSCH reception occasions in the slot according to a first TDRA table (e.g., TDRA table #A1 or TDRA table #A2) configured for the first plurality of candidate PDSCH reception occasions. In response to a slot being included only in the second set of slots, the BS may determine a candidate PDSCH reception occasion of the second plurality of candidate PDSCH reception occasions in the slot according to a second TDRA table (e.g., TDRA table #B1 or TDRA table #B2) configured for the second plurality of candidate PDSCH reception occasions. For example, referring back to FIG. 3, according to TDRA table 320 or TDRA table 330, one candidate PDSCH reception occasion may be determined for the slot. Referring to FIG. 3B, according to TDRA table 350, two candidate PDSCH reception occasions may be determined for the slot.

Referring to FIG. 4, in response to a slot being included in both the first and second sets of slots, the BS may determine a candidate PDSCH reception occasion in the slot according to a union of the first and second TDRA tables (e.g., TDRA table union 340 in FIG. 3A).

In some embodiments of the present disclosure, the BS may determine a candidate PDSCH reception occasion according to a union of the first and second TDRA tables by: in response to a number of non-overlapped SLIVs in the union of the first and second TDRA tables being equal to 1 or the UE supporting receiving a maximum of one PDSCH per slot, determining two candidate PDSCH reception occasions in the slot (e.g., slot #M1) included in both the first and second sets of slots. For example, referring back to FIG. 3A, according to TDRA table union 340, two candidate PDSCH reception occasion may be determined for the slot.

One (e.g., candidate PDSCH reception occasion #1) of the two candidate PDSCH reception occasions may be included in the first plurality of candidate PDSCH reception occasions and the other (e.g., candidate PDSCH reception occasion #2) of two candidate PDSCH reception occasions may be included in the second plurality of candidate PDSCH reception occasions.

In some embodiments of the present disclosure, the BS may determine a candidate PDSCH reception occasion according to a union of the first and second TDRA tables by: in response to a number of non-overlapped SLIVs in the union of the first and second TDRA tables being equal to 1 or the UE supporting receiving a maximum of one PDSCH per slot, determining a single candidate PDSCH reception occasion in the slot (e.g., slot #M1) included in both the first and second sets of slots. For example, referring back to FIG. 3A, according to TDRA table union 340, one candidate PDSCH reception occasion may be determined for the slot. The single candidate PDSCH reception occasion may be included in either the first plurality of candidate PDSCH reception occasions or the second plurality of candidate PDSCH reception occasions.

In some embodiments of the present disclosure, the BS may transmit a single PDSCH scrambled by the first RNTI in the slot included in both the first and second sets of slots. The PUCCH may carry a HARQ-ACK information bit(s) for the single candidate PDSCH reception occasion. In some other embodiments of the present disclosure, the BS may transmit a single PDSCH scrambled by the second RNTI in the slot included in both the first and second sets of slots. The PUCCH may carry a HARQ-ACK information bit(s) for the single candidate PDSCH reception occasion. In yet other embodiments of the present disclosure, the BS may transmit no PDSCH in the slot included in both the first and second sets of slots. The PUCCH may carry a NACK bit(s) for the single candidate PDSCH reception occasion.

In some embodiments of the present disclosure, the PUCCH may carry a first HARQ-ACK codebook (e.g., HARQ-ACK codebook #A1 or HARQ-ACK codebook #A2) for the first plurality of candidate PDSCH reception occasions and a second HARQ-ACK codebook (e.g., HARQ-ACK codebook #B1 or HARQ-ACK codebook #B2) for the second plurality of candidate PDSCH reception occasions. In some examples, the first HARQ-ACK codebook may be arranged in front of the second HARQ-ACK codebook in the PUCCH. In some other examples, the second HARQ-ACK codebook may be arranged in front of the first HARQ-ACK codebook in the PUCCH.

In some embodiments of the present disclosure, the PUCCH may carry a HARQ-ACK codebook including a HARQ-ACK information bit(s) for each candidate PDSCH reception occasion in either the first plurality of candidate PDSCH reception occasions or the second plurality of candidate PDSCH reception occasions. The HARQ-ACK information bits for the candidate PDSCH reception occasions among the first set of slots and the second set of slots in the HARQ-ACK codebook are arranged according to an order (e.g., an ascending or descending order) of the candidate PDSCH reception occasions in the time domain or a predefined rule.

In some examples, the HARQ-ACK information bits for the candidate PDSCH reception occasions are arranged according to an order of slot indexes of the candidate PDSCH reception occasions.

In some embodiments of the present disclosure, in response to a slot included in the union of the first set of slots and the second set of slots including a first candidate PDSCH reception occasion (e.g., candidate PDSCH reception occasion #1) in the first plurality of candidate PDSCH reception occasions and a second candidate PDSCH reception occasion (e.g., candidate PDSCH reception occasion #2) in the second plurality of candidate PDSCH reception occasions, the HARQ-ACK information bit(s) for the first candidate PDSCH reception occasion may be arranged in front of the HARQ-ACK information bit(s) for the second candidate PDSCH reception occasion in the HARQ-ACK codebook. As an alternative, the HARQ-ACK information bit(s) for the second candidate PDSCH reception occasion may be arranged in front of the HARQ-ACK information bit(s) for the first candidate PDSCH reception occasion in the HARQ-ACK codebook.

In some embodiments of the present disclosure, the BS may determine a candidate PDSCH reception occasion of the first plurality of candidate PDSCH reception occasions (e.g., candidate PDSCH reception occasions #A2) in each of the first set of slots (e.g., slot set #A2) according to non-overlapped SLIVs in a first TDRA table (e.g., TDRA table #A2) configured for the first plurality of candidate PDSCH reception occasions.

The BS may further determine a candidate PDSCH reception occasion of the second plurality of candidate PDSCH reception occasions (e.g., candidate PDSCH reception occasions #B2) in each of the second set of slots (e.g., slot set #B2) according to non-overlapped SLIVs in a second TDRA table (e.g., TDRA table #B2) configured for the second plurality of candidate PDSCH reception occasions.

The number of candidate PDSCH reception occasions in a slot of the first set of slots may be equal to a number of non-overlapped SLIVs in the first TDRA table. The number of candidate PDSCH reception occasions in a slot of the second set of slots may be equal to a number of non-overlapped SLIVs in the second TDRA table.

It should be appreciated by persons skilled in the art that the sequence of the operations in exemplary procedure 500 may be changed and some of the operations in exemplary procedure 500 may be eliminated or modified, without departing from the spirit and scope of the disclosure.

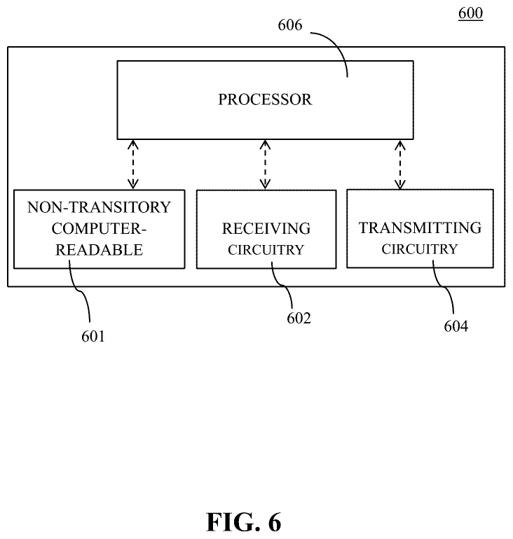

FIG. 6 illustrates a block diagram of an exemplary apparatus 600 according to some embodiments of the present disclosure.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The apparatus 600 may be a base station side apparatus (e.g., a BS) or a communication device (e.g., a UE).

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 are combined into a single device, such as a transceiver. In certain embodiments of the present application, the apparatus 600 may further include an input device, a memory, and/or other components.

In some embodiments of the present disclosure, the non-transitory computer-readable medium 601 may have stored thereon computer-executable instructions to cause a processor to implement the method with respect to the UEs as described above. For example, the computer-executable instructions, when executed, cause the processor 606 interacting with receiving circuitry 602 and transmitting circuitry 604, so as to perform the operations with respect to the UEs described in FIGS. 1-5.

In some embodiments of the present disclosure, the non-transitory computer-readable medium 601 may have stored thereon computer-executable instructions to cause a processor to implement the method with respect to the BSs as described above. For example, the computer-executable instructions, when executed, cause the processor 606 interacting with receiving circuitry 602 and transmitting circuitry 604, so as to perform the operations with respect to the BSs described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
a processor; and
a memory coupled with the processor, the processor configured to cause the UE to:
determine that hybrid automatic repeat request acknowledgement (HARQ-ACK) feedback for a physical downlink shared channel (PDSCH) on each candidate PDSCH reception occasion of a first plurality of candidate PDSCH reception occasions and HARQ-ACK feedback for a PDSCH on each candidate PDSCH reception occasion of a second plurality of candidate PDSCH reception occasions are to be multiplexed in a physical uplink control channel (PUCCH) in a first slot,
wherein the PDSCH on each candidate PDSCH reception occasion of the first plurality of candidate PDSCH reception occasions is scrambled by a first radio network temporary identifier (RNTI) specific to the UE and the PDSCH on each candidate PDSCH reception occasion of the second plurality of PDSCHs is scrambled by a second RNTI common to a group of UEs including the UE; and
transmit the PUCCH in the first slot.

2. The UE of claim 1, wherein the first plurality of candidate PDSCH reception occasions are included in a first set of slots and the second plurality of candidate PDSCH reception occasions are included in a second set of slots.

3. The UE of claim 2, wherein the first set of slots is determined based on a first HARQ-ACK feedback timing set configured for the first plurality of candidate PDSCH reception occasions and the second set of slots is determined based on a second HARQ-ACK feedback timing set configured for the second plurality of candidate PDSCH reception occasions.

4. The UE of claim 2, wherein the processor is further configured to cause the UE to:
in response to a slot being included only in the first set of slots, determine a candidate PDSCH reception occasion of the first plurality of candidate PDSCH reception occasions in the slot according to a first time domain resource allocation (TDRA) table configured for the first plurality of candidate PDSCH reception occasions;
in response to a slot being included only in the second set of slots, determine a candidate PDSCH reception occasion of the second plurality of candidate PDSCH reception occasions in the slot according to a second TDRA table configured for the second plurality of candidate PDSCH reception occasions; and
in response to a slot being included in both the first and second sets of slots, determine a candidate PDSCH reception occasion in the slot according to a union of the first and second TDRA tables.

5. The UE of claim 4, wherein the processor determines a candidate PDSCH reception occasion according to a union of the first and second TDRA tables by:
in response to a number of non-overlapped start and length indicator values (SLIVs) in the union of the first and second TDRA tables being equal to 1 or the UE supporting receiving a maximum of one PDSCH per slot, determining two candidate PDSCH reception occasions in the slot included in both the first and second sets of slots.

6. The UE of claim 5, wherein one of the two candidate PDSCH reception occasions is included in the first plurality of candidate PDSCH reception occasions and the other of two candidate PDSCH reception occasions is included in the second plurality of candidate PDSCH reception occasions.

7. The UE of claim 4, wherein the processor determines a candidate PDSCH reception occasion according to a union of the first and second TDRA tables by:
in response to a number of non-overlapped start and length indicator values (SLIVs) in the union of the first and second TDRA tables being equal to 1 or the UE supporting receiving a maximum of one PDSCH per slot, determining a single candidate PDSCH reception occasion in the slot included in both the first and second sets of slots.

8. The UE of claim 7, wherein the single candidate PDSCH reception occasion is included in either the first plurality of candidate PDSCH reception occasions or the second plurality of candidate PDSCH reception occasions.

9. The UE of claim 8, wherein the processor is further configure to cause the UE to:
generate a HARQ-ACK information bit for the single candidate PDSCH reception occasion in response to receiving a single PDSCH scrambled by the first RNTI in the slot included in both the first and second sets of slots;
generate a HARQ-ACK information bit for the single candidate PDSCH reception occasion in response to receiving a single PDSCH scrambled by the second RNTI in the slot included in both the first and second sets of slots; and
generate a negative acknowledgement (NACK) bit for the single candidate PDSCH reception occasion in response to not receiving a PDSCH in the slot included in both the first and second sets of slots.

10. The UE of claim 1, wherein the PUCCH carries a first HARQ-ACK codebook for the first plurality of candidate PDSCH reception occasions and a second HARQ-ACK codebook for the second plurality of candidate PDSCH reception occasions.

11. The UE of claim 2, wherein the processor is further configure to cause the UE to:
generate a HARQ-ACK information bit for each candidate PDSCH reception occasion in either the first plurality of candidate PDSCH reception occasions or the second plurality of candidate PDSCH reception occasions; and
arrange HARQ-ACK information bits for the candidate PDSCH reception occasions among the first set of slots and the second set of slots in a HARQ-ACK codebook according to an order of the candidate PDSCH reception occasions in a time domain or a predefined rule, wherein the HARQ-ACK codebook is carried in the PUCCH.

12. The UE of claim 11, wherein in response to a slot included in the union of the first set of slots and the second set of slots including a first candidate PDSCH reception occasion in the first plurality of candidate PDSCH reception occasions and a second candidate PDSCH reception occasion in the second plurality of candidate PDSCH reception occasions:
a HARQ-ACK information bit for the first candidate PDSCH reception occasion is arranged in front of a HARQ-ACK information bit for the second candidate PDSCH reception occasion in the HARQ-ACK codebook, or
the HARQ-ACK information bit for the second candidate PDSCH reception occasion is arranged in front of the HARQ-ACK information bit for the first candidate PDSCH reception occasion in the HARQ-ACK codebook.

13. The UE of claim 2, wherein the processor is further configured to cause the UE to:
determine a candidate PDSCH reception occasion of the first plurality of candidate PDSCH reception occasions in each of the first set of slots according to non-overlapped start and length indicator values (SLIVs) in a first time domain resource allocation (TDRA) table configured for the first plurality of candidate PDSCH reception occasions; and
determine a candidate PDSCH reception occasion of the second plurality of candidate PDSCH reception occasions in each of the second set of slots according to non-overlapped SLIVs in a second TDRA table configured for the second plurality of candidate PDSCH reception occasions.

14. The UE of claim 13, wherein a number of candidate PDSCH reception occasions in a slot of the first set of slots is equal to a number of non-overlapped SLIVs in the first TDRA table and a number of candidate PDSCH reception occasions in a slot of the second set of slots is equal to a number of non-overlapped SLIVs in the second TDRA table.

15. (canceled)

16. A processor for wireless communication, comprising:
at least one controller coupled with at least one memory and configured to cause the processor to:
determine that hybrid automatic repeat request acknowledgement (HARQ-ACK) feedback for a physical downlink shared channel (PDSCH) on each candidate PDSCH reception occasion of a first plurality of candidate PDSCH reception occasions and HARQ-ACK feedback for a PDSCH on each candidate PDSCH reception occasion of a second plurality of candidate PDSCH reception occasions are to be multiplexed in a physical uplink control channel (PUCCH) in a first slot,
wherein the PDSCH on each candidate PDSCH reception occasion of the first plurality of candidate PDSCH reception occasions is scrambled by a first radio network temporary identifier (RNTI) specific to the UE and the PDSCH on each candidate PDSCH reception occasion of the second plurality of PDSCHs is scrambled by a second RNTI common to a group of processors including the processor; and
transmit the PUCCH in the first slot.

17. The processor of claim 16, wherein the first plurality of candidate PDSCH reception occasions are included in a first set of slots and the second plurality of candidate PDSCH reception occasions are included in a second set of slots.

18. The processor of claim 17, wherein the first set of slots is determined based on a first HARQ-ACK feedback timing set configured for the first plurality of candidate PDSCH reception occasions and the second set of slots is determined based on a second HARQ-ACK feedback timing set configured for the second plurality of candidate PDSCH reception occasions.

19. The processor of claim 17, wherein the controller is further configured to cause the processor to:
in response to a slot being included only in the first set of slots, determine a candidate PDSCH reception occasion of the first plurality of candidate PDSCH reception occasions in the slot according to a first time domain resource allocation (TDRA) table configured for the first plurality of candidate PDSCH reception occasions;
in response to a slot being included only in the second set of slots, determine a candidate PDSCH reception occasion of the second plurality of candidate PDSCH reception occasions in the slot according to a second TDRA table configured for the second plurality of candidate PDSCH reception occasions; and
in response to a slot being included in both the first and second sets of slots, determine a candidate PDSCH reception occasion in the slot according to a union of the first and second TDRA tables.

20. The processor of claim 16, wherein the PUCCH carries a first HARQ-ACK codebook for the first plurality of candidate PDSCH reception occasions and a second HARQ-ACK codebook for the second plurality of candidate PDSCH reception occasions.

21. A method performed by a user equipment (UE), the method comprising:
determining that hybrid automatic repeat request acknowledgement (HARQ-ACK) feedback for a physical downlink shared channel (PDSCH) on each candidate PDSCH reception occasion of a first plurality of candidate PDSCH reception occasions and HARQ-ACK feedback for a PDSCH on each candidate PDSCH reception occasion of a second plurality of candidate PDSCH reception occasions are to be multiplexed in a physical uplink control channel (PUCCH) in a first slot,
wherein the PDSCH on each candidate PDSCH reception occasion of the first plurality of candidate PDSCH reception occasions is scrambled by a first radio network temporary identifier (RNTI) specific to the UE and the PDSCH on each candidate PDSCH reception occasion of the second plurality of PDSCHs is scrambled by a second RNTI common to a group of UEs including the UE; and
transmitting the PUCCH in the first slot.
